(19) United States
(12) Patent Application Publication
(10) Pub. No.: US 2008/0219382 A1
(43) Pub. Date: Sep. 11, 2008

(54) SIGNAL RECEIVING CIRCUIT TO TRANSMIT HIGH SPEED SIGNAL

(75) Inventor: Seung-young AHN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/853,295

(22) Filed: Sep. 11, 2007

(30) Foreign Application Priority Data
Mar. 6, 2007 (KR) 2007-22062

(51) Int. Cl. H04L 27/00

(52) U.S. Cl. 375/316

(57) ABSTRACT

A signal receiving circuit to transmit a high speed signal, includes a signal processing unit having a terminal resistor, a board unit having a signal transmitting unit to transmit an external signal to the signal processing unit and a parasitic capacitance offsetting unit which is formed on the board unit and to offset parasitic capacitance existing in the signal processing unit.

### CROSS-REFERENCE TO RELATED APPLICATIONS

This application claims priority under 35 U.S.C. §119(a) from Korean Patent Application No. 10-2007-0022062, filed on Mar. 6, 2007 in the Korean Intellectual Property Office, the disclosure of which is incorporated herein by reference.

### BACKGROUND OF THE INVENTION

1. Field of the Invention

Apparatuses and methods consistent with the present general inventive concept relate an improved signal receiving circuit to transmit a high speed signal, and more particularly to a signal receiving circuit to receiver a high frequency signal.

2. Description of the Related Art

An electronic apparatus such as a computer and other apparatuses known in the art includes a board part where a plurality of chips are mounted. The chip receives or transmits various signals through a signal wiring formed on the board part. A signal processing speed that the chip can process has significantly improved. It is accordingly important that the signal is transmitted accurately without distortion.

FIG. 1 is a schematic diagram illustrating a conventional electronic circuit. As illustrated in FIG. 1, the signal output by a sending end 10 is transmitted through a signal wiring 20 to a terminal part 30 of a receiving circuit. A terminal resistor 31 is provided in the terminal part 30. The signal wiring 20 formed on the board part is made of conductive material such as copper. However, as a length of the signal wiring 20 is increased, the resistance and influence by various types of outer noises on the signal wiring 20 increases. Also, in a signal transmitting process, there is a possibility that loss of the signal to other parts of the board part may occur. Such a signal loss occurs more seriously in a high frequency signal than in a low frequency signal. If a signal transmitting speed is increased, the high frequency signal which repeats ‘high’ and ‘low’ is also increased. Accordingly, the distortion of the high frequency signal is increased and the signal cannot be normally transmitted. If the distortion of such a high frequency signal is represented with an equivalent circuit, a capacitor is connected to the terminal resistor 31, thus it looks as if a low pass filter is formed. Such a parasitic capacitance C causes decreasing amplitude of the high frequency signal and distorting of the high frequency signal.

### SUMMARY OF THE INVENTION

The present general inventive concept to provide a signal receiving circuit by which signal distortion is prevented and especially characteristics in receiving a high frequency signal are improved.

Additional aspects and utilities of the present general inventive concept will be set forth in part in the description which follows and, in part, will be obvious from the description, or may be learned by practice of the present general inventive concept.

The foregoing and/or other aspects utilities of the present general inventive concept can be achieved by providing a signal receiving circuit to transmit a high speed signal, including a signal processing unit having a terminal resistor, a board unit having a signal transmitting unit to transmit a signal to the signal processing unit and a parasitic capacitance offsetting unit which is formed on the board unit and to offset parasitic capacitance existing in the signal processing unit.

The parasitic capacitance offsetting unit may include an inductor which is connected with the terminal resistor in parallel.

The inductor may include a wiring pattern which extends in a spiral direction from a predetermined center portion.

The board unit may include a first printed circuit layer, a second printed circuit layer which is provided under the first printed circuit layer and is superposed with the first printed circuit layer, and the wiring pattern is formed in the first printed circuit layer.

The inductor may include an additional pattern which is formed in the first printed circuit layer, and a connecting pattern which electrically connects the center portion with the additional pattern and is formed in the second printed circuit layer.

The inductor may include copper.

An inductance of the inductor may be set corresponding to a magnitude of the parasitic capacitance.

A resonant frequency based on the parasitic capacitance and the inductance of the inductor may be a maximum frequency of the signal transmitted from the signal transmitting unit.

The parasitic capacitance offsetting unit may further include a short-circuit preventing resistor which is serially connected with the inductor.

A transmitting speed of the signal transmitted to the signal transmitting unit may be in a range from 1 [Gbps] to 10 [Gbps].

The foregoing and/or other aspects and utilities of the present general inventive concept can also be achieved by providing a signal receiving circuit including a terminal unit which has a terminal resistor and to receive an external signal and an inductor which is connected to the terminal resistor and to offset a parasitic capacitance existing in the terminal unit.

The inductor is serially connected to the terminal resistor.

An inductance of the inductor is set corresponding to a magnitude of the parasitic capacitance.

A resonant frequency based on the parasitic capacitance and the inductance of the inductor may be a maximum frequency of the signal transmitted from the terminal unit.

A transmitting speed of the signal received by the terminal unit may be in a range from 1 [Gbps] to 10 [Gbps].

The foregoing and/or other aspects and utilities of the general inventive concept may also be achieved by providing a signal receiving apparatus, including a signal processing unit having a terminal resistor and a parasitic capacitance, a receiving unit to receive an external signal and to transmit the signal to the signal processing unit and an inductor coupled to the terminal resistor, wherein an inductance of the inductor corresponds to the parasitic capacitance of the signal processing unit.

The foregoing and/or other aspects and utilities of the general inventive concept may also be achieved by providing an electronic communication apparatus, including a housing and a signal receiving apparatus disposed in the housing including a signal processing unit having a terminal resistor and a parasitic capacitance, a receiving unit to receive an external signal and to transmit the signal to the signal processing unit and an inductor coupled to the terminal resistor, wherein an inductance of the inductor corresponds to the parasitic capacitance of the signal processing unit.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic diagram illustrating a conventional electronic circuit;

FIG. 2 is a schematic diagram illustrating a signal receiving circuit according to an exemplary embodiment of the present general inventive concept;

FIG. 3 is a schematic diagram illustrating a signal receiving circuit according to an other exemplary embodiment of the present general inventive concept;

FIG. 4A and FIG. 4B illustrate an inductor according to the other exemplary embodiment of the present general inventive concept;

FIG. 5 is a graph illustrating a received signal gain with regard to frequency for the signal receiving circuit according to the other exemplary embodiment of the present general inventive concept; and

FIGS. 6A to 6D are drawings illustrating an effect of a parasitic capacitance offsetting unit according to the other exemplary embodiment of the present general inventive concept.

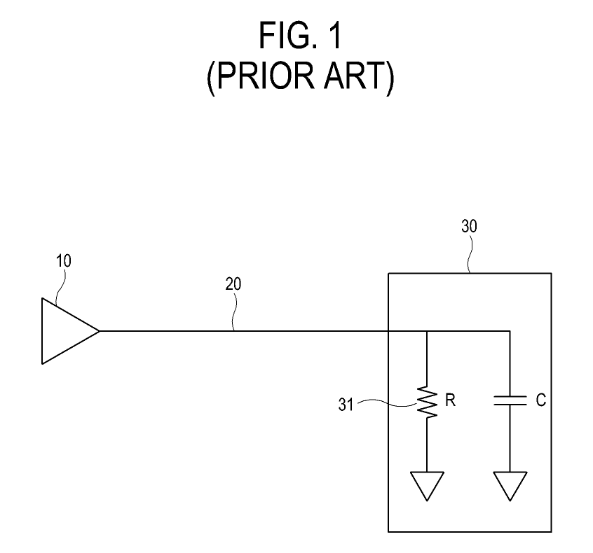

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

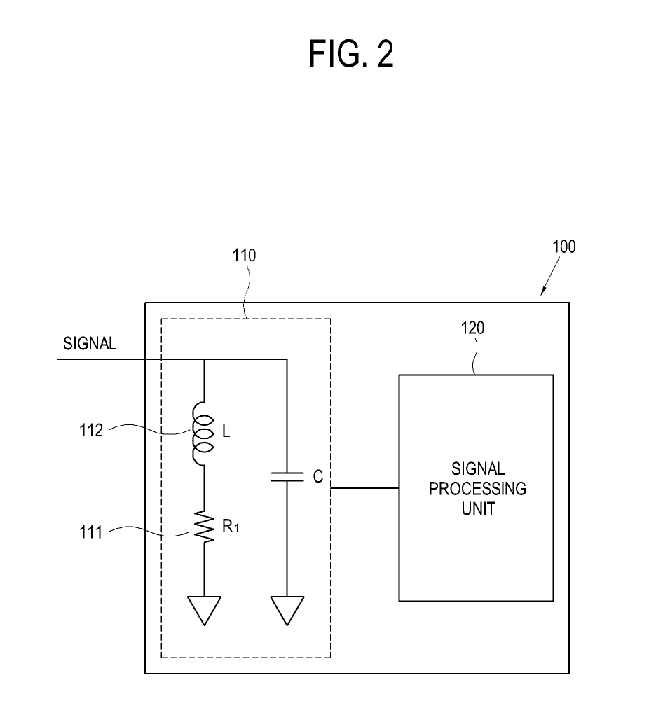

FIG. 2 is a schematic diagram illustrating a signal receiving circuit according to an exemplary embodiment of the present general inventive concept.

The signal receiving circuit 100 includes a terminal unit 110 which receives an external signal and a signal processing unit 120 which processes the received signal. The signal receiving circuit 100 according to this exemplary embodiment may be embody a chip. Also, the signal receiving circuit 100 may be provided in a circuit substrate or other embodiments known in the art to receive the signal and may be connected with a number of signal wirings formed on the circuit substrate.

The terminal unit 110 has a terminal resistor 111 and an inductor 112 which is connected to the terminal resistor (R1) 111.

The terminal resistor 111 is formed at an end portion of the terminal unit 110 where the signal is received, and provides a reference voltage to classify the received signal between a high signal and a low signal. The signal transmitting speed of the signal received by the signal receiving circuit 100 is, for example, in a range from 1 Gbps to 10 Gbps, and tends to increase continuously. If the signal is transmitted at such a high speed, transitioning between high and low in the signal is so rapid and a probability to increase high frequency components in the signal is increased.

Amplitude of the external signal is decreased due to various noises, a resistance generated by a signal transmitting device. The high frequency signal is influenced more by the noises and the resistance, than a low frequency signal. The phenomenon of a decreased gain in the high frequency signal among the received signal brings about an effect as if a high frequency cut-off filter of a resistance-capacitor exists at the terminal unit 110, which may be expressed by an equivalent circuit as a parasitic capacitance C as illustrated in FIG. 2.

The inductor 112 is serially connected to the terminal resistor 111 and performs a function of offsetting the parasitic capacitance C. That is, the inductor 112 functioning contrary to a capacitor is provided to the terminal unit 110 thus enabling the high frequency signal to be transmitted to the signal processing unit 120. Inductance L of the inductor 112 should be decided in consideration of an amount of the parasitic capacitance C. That is, to offset the parasitic capacitance C due to the parasitic capacitor, the inductor 112 can have the inductance L by which an impedance matching can be achieved. Also, to improve characteristics in receiving the high frequency signal, a resonant frequency based on the parasitic capacitance C and the inductance L can be chosen to be a maximum frequency of the signal received by the terminal unit 110. That is, through performing the impedance matching for a frequency band of a lowest receiving rate, the characteristics in receiving the high frequency signal can be improved.

The signal receiving circuit 100 according to this exemplary embodiment is provided as a chip, as described above, and the inductor 112 mounted in the chip may be connected to the terminal resistor 111 in series. According to another exemplary embodiment, the inductor may be connected to the terminal resistor 111 in parallel. However, an additional resistor and other elements known in the art are required to be connected.

The signal processing unit 120 performs a function of the signal receiving circuit 100 by processing the received signal.

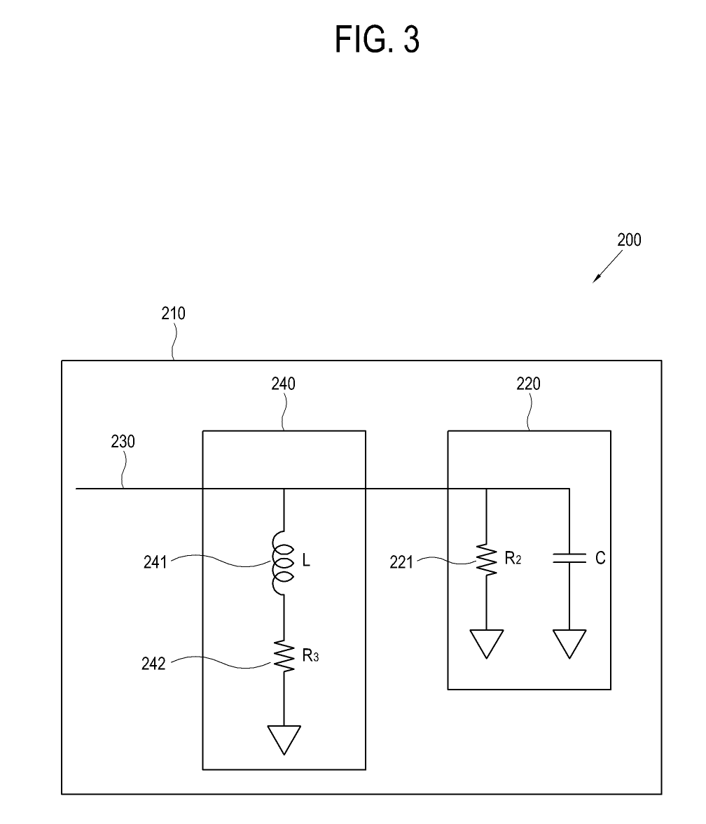

FIG. 3 is a schematic diagram illustrating a signal receiving circuit according to an other exemplary embodiment of the present general inventive concept.

The signal receiving circuit 200 according to this exemplary embodiment includes a board unit 210, a signal processing unit 220 formed on the board unit 210, a signal transmitting unit 230 transmitting the signal to the signal processing unit 220, and a parasitic capacitance offsetting unit 240 connected to the signal processing unit 220.

The board unit 210 has various circuit devices such as the signal processing unit 220, and has the signal transmitting unit 230 to transmit the signal. The board unit 210 may be embodied as a printed circuit board, and may be of a layer structure where a number of printed circuit layers are superposed. The board unit 210 of a multi-layer structure may include a grounding layer (not illustrated) contacting the signal transmitting unit 230, and may further include a connecting wiring (not illustrated) passing through an insulating layer and connecting the grounding layer with the signal transmitting unit 230.

If the signal is transmitted through the conductive connecting wiring and the signal transmitting unit 230, signal amplitude may be decreased due to internal resistance of the wiring and the signal transmitting unit 230. Also, signal loss may be generated due to electric current leakage to the insulating layer. Accordingly, a structural problem of the board unit 210 having the signal transmitting unit 230 brings about a signal distortion and an effect as if a capacitor is connected to the terminal resistor (R2) 221 of the signal processing unit 220 which receives an external signal.

According to this exemplary embodiment, the signal transmitting unit 230 can include a circuit pattern made of copper or other conductive materials on the board unit 210. Also, if the signal transmitting unit 230 is of a configuration capable of transmitting the signal, it may include a signal line or a cable in addition to the circuit pattern.

The signal processing unit 220 is a device to receive and process the signal transmitted by the signal transmitting unit 230 and may be a chip or other embodiments known in the art. The signal processing unit 220 includes the terminal resistor 221 at the terminal unit where the signal is received, and the parasitic capacitance C due to the capacitor described above is formed at the terminal unit.

The parasitic capacitance offsetting unit 240 is formed on the board unit 210 and is provided between the signal transmitting unit 230 and the signal processing unit 220. The parasitic capacitance offsetting unit 240 includes an inductor 241 to offset the parasitic capacitance C existing at the signal processing unit 220. As the inductor 241 is physically not easy to connect with the terminal resistor 221 in serial in the signal processing unit 220 configured as a chip, the inductor 241 is connected with the terminal resistor 221 in parallel.

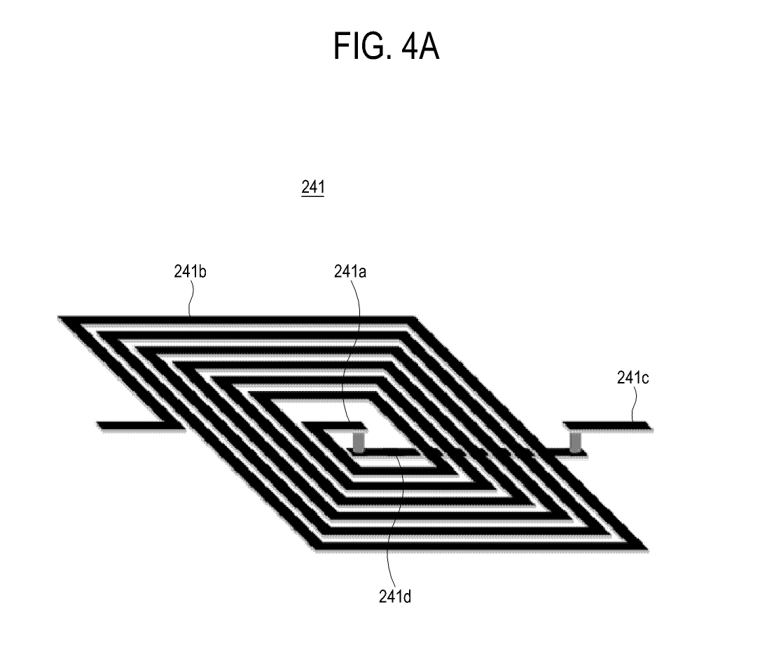

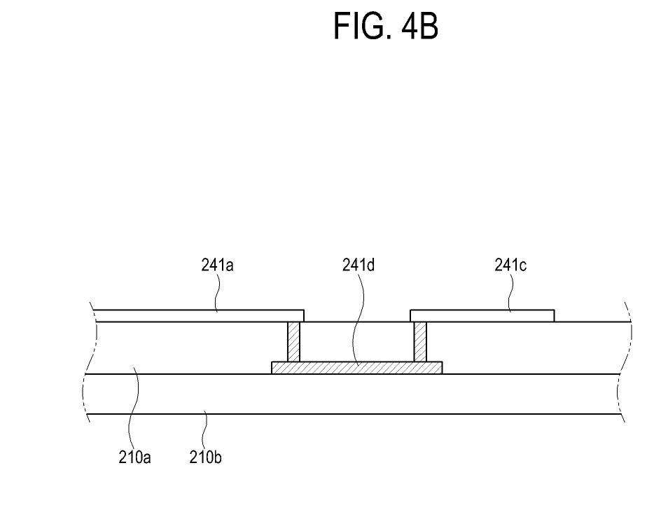

FIG. 4A and FIG. 4B illustrate the inductor according to this exemplary embodiment. The inductor 241 is formed as a wiring pattern 241b spirally extending from a predetermined center portion 241a. Inductance L may be controlled through adjusting a length of the wiring pattern. As described above, the inductance L of the inductor 241 is set in consideration of the parasitic capacitance C. The inductor 241 is formed through a plurality of printed circuit layers 210a and 210b so that the wiring pattern 241b formed as one line outwardly from the center portion 241a can connect the terminal resistor 221 with a short-circuit preventing resistor 242. As illustrated in FIG. 4B, the board unit 210 according to this exemplary embodiment includes a first printed circuit layer 210a and a second printed circuit layer 210b formed superposed to each other with an insulation therebetween. The wiring pattern 241b is formed in the first printed circuit layer 210a. The inductor 241 includes an additional pattern 241c formed in the first printed circuit layer 210a where the wiring pattern 241b is formed, and a connecting pattern 241d, which is formed in the second printed circuit layer 210b, to connect the additional pattern 241c with the center portion 241a.

That is, the inductor 241 is connected with the terminal resistor 221 and the short-circuit preventing resistor 242 through terminals of the wiring pattern 241b and the additional pattern 241c respectively. Also, the patterns 241b and 241c formed in different printed circuit layers 210a and 210b are electrically connected therebetween through the connecting pattern 241d. The wiring pattern 241b and the additional pattern 241c separated from each other formed in the same first printed circuit layer 210a are connected by the connecting pattern 241d formed in the second printed circuit layer 210b. Such an inductor 241 may be manufactured with material such as copper or other material known in the art. The material and shape of the inductor 241 is not limited to the above description and may have various constitutions known in the art.

The parasitic capacitance offsetting unit 240 further includes a short-circuit preventing resistor 242 serially connected to the inductor 241. The inductor 241 performs cutting off of the signal having a low frequency or a continuing of a direct current component whereas it passes the high frequency signal. Accordingly, a problem of creating a short circuit of the inductor 241 with the grounding terminal, without transmitting the received signal to the terminal resistor 221, may occur. To avoid this problem, the short-circuit preventing resistor 242 is disposed to maintain a predetermined voltage between the inductor 241 and the grounding terminal.

According to this exemplary embodiment, each resistance value of the terminal resistor 221 and the short-circuit preventing resistor 242 is twice as that of the terminal resistor 111 according to the exemplary embodiment. Suppose that the signal receiving circuit 100 of the exemplary embodiment and the signal processing unit 220 of this exemplary embodiment are the same chip, the same reference voltage should be generated by the terminal resistors 111 and 221 connected to the signal receiving 100 and the signal processing unit 220 respectively. In this exemplary embodiment, as the short-circuit preventing resistor 242 is added, the overall resistance value due to the short-circuit preventing resistor 242 connected to the terminal resistor 221 in parallel should be the same as the resistance value of the terminal resistor 111 of the exemplary embodiment. Accordingly, if the resistance value of the terminal resistor 111 according to the exemplary embodiment is 100 [Ω], the resistance values of the terminal resistor 221 and the short-circuit preventing resistor 242 according to this exemplary embodiment should be 200 [Ω], respectively.

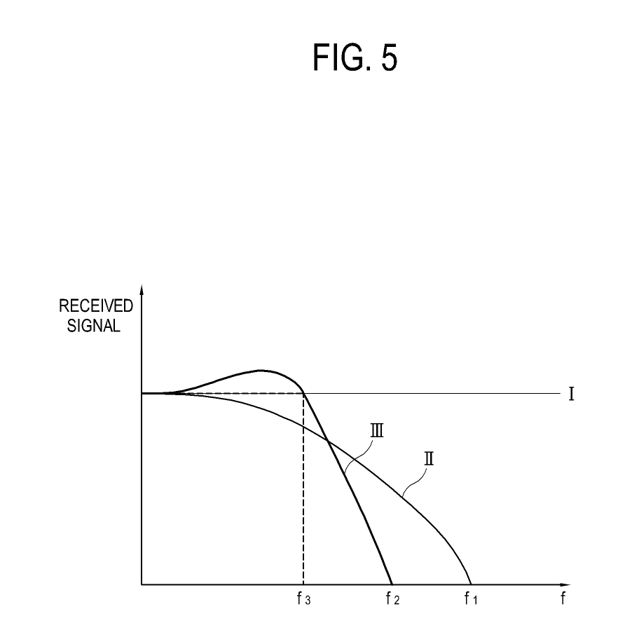

FIG. 5 is a graph illustrating a received signal gain with regard to a frequency of the signal receiving circuit according to an other exemplary embodiment of the present general inventive concept. The X axis of the graph represents the frequency of the received signal and the Y axis represents the received signal gain.

An ideal signal receiving circuit, where there is no noise and no resistance component, has received signal gain represented by a straight line such as a first line I. The received signal gain, for example, maintains its magnitude to be the same as it is transmitted from a predetermined transmitting terminal. However, the received signal gain decreases as illustrated in a second line II as the frequency increases, due to structural characteristics of the board unit 210 including the signal transmitting unit 230. If the inductor 241 is added to offset the parasitic capacitance C as illustrated in this exemplary embodiment, the received signal gain is changed from the second line II into a third line III. As illustrated in FIG. 5, according to the second line II, a predetermined frequency range 0˜f₃ exists where the received signal gain is not decreased. The maximum frequency of a conventional receivable frequency illustrated in the second line II is f₁. However, if the inductor 241 is adopted, the maximum receivable frequency is changed from f₁ to f₂. That is, though a range of the maximum frequency to be receivable is decreased, the frequency range where the received signal gain is not decreased is enlarged. If the frequency range of the signal received by the signal receiving circuit 200 is lower than f₃, the signal gain is not decreased. That is, the maximum frequency f₃ not decreasing the gain may be set to be higher than the received signal by adjusting the inductance of the inductor 241.

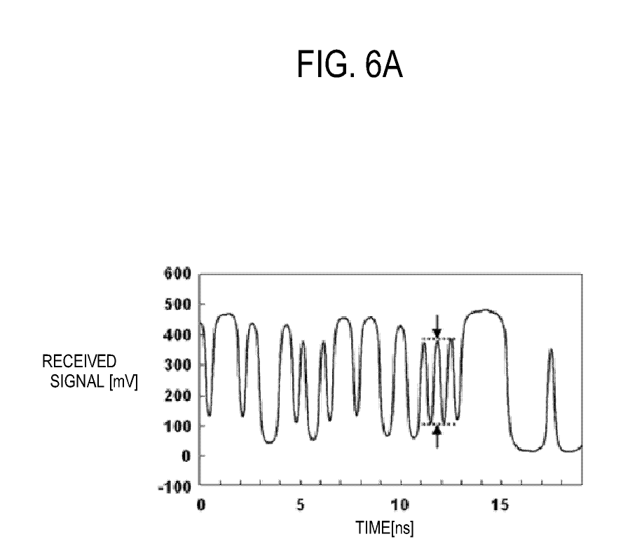

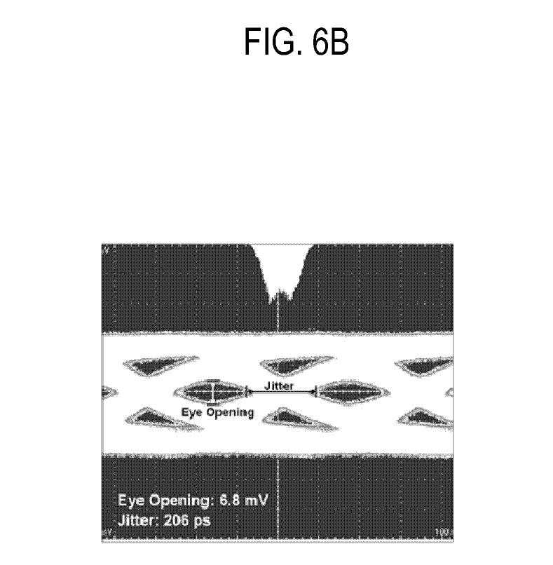

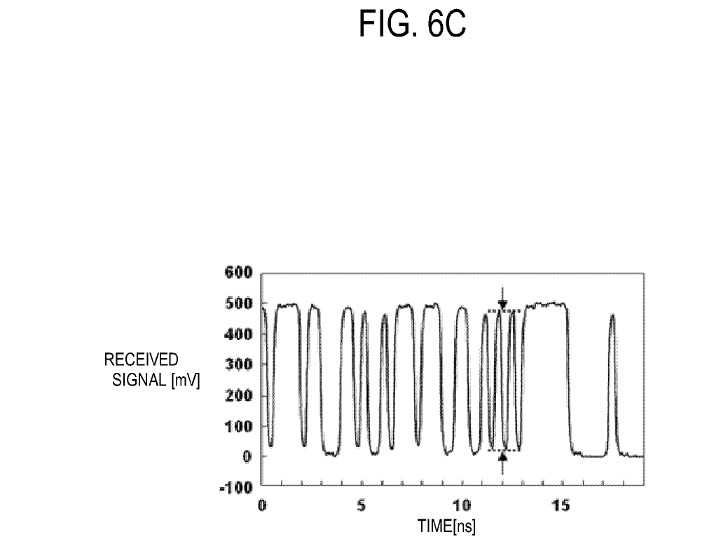

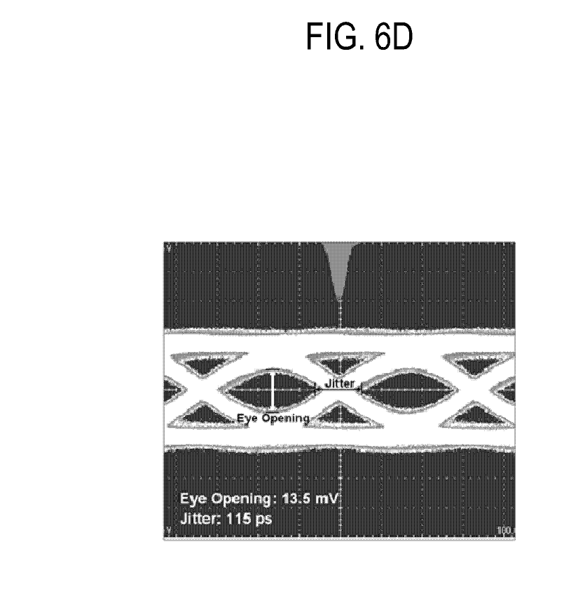

FIGS. 6A to 6D are drawings illustrating an effect of the parasitic capacitance offsetting unit according to the other exemplary embodiment of the present general inventive concept. FIG. 6A illustrates a received signal waveform when the inductor is not included. FIG. 6B illustrates an eye diagram corresponding to FIG. 6A. FIG. 6C illustrates the received signal waveform according to this exemplary embodiment, and FIG. 6D illustrates the eye diagram corresponding to FIG. 6C. The eye diagram is a diagram where the signal waveform is divided in a predetermined unit length to be superposed, and a wider opening of an eye shaped like an open eye with a smaller jitter of the distance between the eye shapes corresponds to better signal characteristics.

As illustrated in FIG. 6A, signal amplitude in the high frequency band where high and low in the received signal are rapidly changed is decreased and smaller than that in other band portions. On the other hand, in the signal waveform of FIG. 6C, it can be seen that the signal amplitude in the high frequency band is not decreased but about the same as that in the other band portions. It can also be seen that as the parasitic capacitance C is offset by the inductor 241, the high frequency signal is normally received without distortion in the amplitude.

In addition, comparing FIG. 6B with FIG. 6D, the eye opening of FIG. 6D is wider than that of FIG. 6B, and the jitter is smaller in FIG. 6D than in FIG. 6B. Therefore, it can be seen that the signal characteristics are improved by adding the inductor 241.

As described above, according to the present general inventive concept, the signal receiving circuit by which the signal distortion is prevented with characteristics improved especially in receiving the high frequency signal may be provided.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A signal receiving circuit to transmit a high speed signal, comprising:
a signal processing unit having a terminal resistor;
a board unit having a signal transmitting unit to transmit a signal to the signal processing unit; and
a parasitic capacitance offsetting unit which is formed on the board unit and to offset parasitic capacitance existing in the signal processing unit.

2. The signal receiving circuit according to claim 1, wherein the parasitic capacitance offsetting unit comprises:
an inductor which is connected with the terminal resistor in parallel.

3. The signal receiving circuit according to claim 2, wherein the inductor comprises:
a wiring pattern which extends in a spiral direction from a predetermined center portion.

4. The signal receiving circuit according to claim 3, wherein the board unit comprises:
a first printed circuit layer;
a second printed circuit layer which is provided under the first printed circuit layer and is superposed with the first printed circuit layer; and
the wiring pattern is formed in the first printed circuit layer.

5. The signal receiving circuit according to claim 4, wherein the inductor comprises:
an additional pattern which is formed in the first printed circuit layer; and
a connecting pattern which electrically connects the center portion with the additional pattern and is formed in the second printed circuit layer.

6. The signal receiving circuit according to claim 3, wherein the inductor comprises:
copper.

7. The signal receiving circuit according to claim 2, wherein:
an inductance of the inductor is set corresponding to a magnitude of the parasitic capacitance.

8. The signal receiving circuit according to claim 7, wherein:
a resonant frequency based on the parasitic capacitance and the inductance of the inductor is a maximum frequency of the signal transmitted from the signal transmitting unit.

9. The signal receiving circuit according to claim 2, wherein the parasitic capacitance offsetting unit further comprises:
a short-circuit preventing resistor which is serially connected with the inductor.

10. The signal receiving circuit according to claim 1, wherein:
a transmitting speed of the signal transmitted to the signal transmitting unit is in a range from 1 [Gbps] to 10 [Gbps].

11. A signal receiving circuit, comprising:
a terminal unit having a terminal resistor and to receive an external signal; and
an inductor which is connected to the terminal resistor and to offset a parasitic capacitance existing in the terminal unit.

12. The signal receiving circuit according to claim 11, wherein:
the inductor is serially connected to the terminal resistor.

13. The signal receiving circuit according to claim 11, wherein:
an inductance of the inductor is set corresponding to a magnitude of the parasitic capacitance.

14. The signal receiving circuit according to claim 11, wherein:
a resonant frequency based on the parasitic capacitance and the inductance of the inductor is a maximum frequency of the signal transmitted from the terminal unit.

15. The signal receiving circuit according to claim 11, wherein:
a transmitting speed of the signal received by the terminal unit is in a range from 1 [Gbps] to 10 [Gbps].

16. A signal receiving apparatus, comprising:
a signal processing unit having a terminal resistor and a parasitic capacitance;
a receiving unit to receive an external signal and to transmit the signal to the signal processing unit; and
an inductor coupled to the terminal resistor,
wherein an inductance of the inductor corresponds to the parasitic capacitance of the signal processing unit.

17. The apparatus of claim 16, wherein the inductor is coupled to the terminal resistor in series.

18. The apparatus of claim 16, wherein the inductor comprises:
a wiring pattern extending in a spiral direction from a predetermined center portion.

19. The apparatus of claim 16, further comprising:
a short circuit preventing resistor coupled in series to the inductor.

20. An electronic communication apparatus, comprising:
a housing; and
a signal receiving apparatus disposed in the housing comprising:
a signal processing unit having a terminal resistor and a parasitic capacitance;
a receiving unit to receive an external signal and to transmit the signal to the signal processing unit; and
an inductor coupled to the terminal resistor,
wherein an inductance of the inductor corresponds to the parasitic capacitance of the signal processing unit.
